(19) United States
(12) Patent Application Publication
(10) Pub. No.: US 2015/0249759 A1
(43) Pub. Date: Sep. 3, 2015

(54) IMAGE FORMING APPARATUS AND MAINTENANCE METHOD THEREFOR

(71) Applicant: KYOCERA Document Solutions Inc., Osaka (JP)

(72) Inventor: Yosuke MORISHITA, Osaka (JP)

(73) Assignee: KYOCERA DOCUMENT SOLUTIONS INC., Osaka (JP)

(21) Appl. No.: 14/634,357

(22) Filed: Feb. 27, 2015

(30) Foreign Application Priority Data
Feb. 28, 2014 (JP) 2014-038404

(51) Int. Cl. H04N 1/00; H04N 1/21

(52) U.S. Cl. CPC H04N 1/00482; H04N 1/2108; H04N 1/0044; H04N 1/00411; H04N 2201/0082; H04N 2201/0093; H04N 2201/0094

(57) ABSTRACT

The current value comparison unit configured to calculate a first variation amount by subtracting a reference value of a reference chart from a current registered value of a current chart for every setting item based on the reference values for every setting item registered in advance and the current registered values for every setting item. The preceding value comparison unit configured to calculate a second variation amount by subtracting the reference value of the reference chart from a preceding registered value of a preceding chart for every setting item based on the reference values and the preceding registered values for every setting item registered before changing the current registered value. The priority order setting unit configured to display the setting items in descending order of priorities based on the first variation amount and the second variation amount.

### CROSS-REFERENCE TO RELATED APPLICATION

This application claims the benefit of Japanese Patent Application No. 2014-038404, filed on Feb. 28, 2014, all of which is hereby incorporated by reference in its entirety.

### BACKGROUND OF THE INVENTION

The present invention relates to image forming apparatus and a maintenance method.

For image forming apparatus like copiers, facsimile machines, and multifunction peripherals, many maintenance methods have existed. For instance, it is known that image adjustment apparatus including a storage unit, a signal converting unit, a display unit, an adjustment unit, and an adjustment data output unit. The storage unit reads and stores an image to be adjusted. The signal converting unit reads out the image stored in the storage unit and converts the image to signals. The display unit displays the image converted by the signal converting unit together with a specific reference image on a display device. The adjustment unit adjusts conversion properties of the signal converting unit. The adjustment data output unit outputs adjusted data by the adjustment unit as the adjustment data corresponding to the image to be adjusted stored in the storage unit. Hereby, it is possible to let the user execute a fixed level of adjustment for the image read by a scanner without influences of the display device and the environment changes.

Moreover, an image forming apparatus described below is known, wherein a scanner reads an original to obtain an image data; an image processing unit performs the tone reproduction correction and the pseudo tone processing for the image data thus read; and a printer prints out an image corresponding to the image data thus processed. In this apparatus, a tone chart for the image forming conditions is outputted, a tone level suitable to the image forming condition is selected based on the outputted tone chart, and the image forming condition corresponding to the tone level is detected. And then, the image forming apparatus outputs a test pattern for the tone reproduction based on the detected image forming condition, and reads again the test pattern by the scanner. By comparing the tone data read by the scanner and the tone data of the test pattern, the image forming apparatus calculates plural correction data for every tone, and stores them in the memory unit. Hereby, it is possible to adjust the tone reproduction regardless of an individual difference or an adjustment environment.

The other image forming apparatus is known, which includes a scanning unit that scans an original and reads image data corresponding to the original, and a plotting unit that prints out the image data read by the scanning unit. In this image forming apparatus, after a test chart including margins and an image area is scanned by the scanning unit, sizes of the margins are calculated, and the calculated margin sizes are compared with reference margin sizes that have been inputted in advance. The image forming apparatus automatically executes the adjustment of a writing position of the image data (the registration alignment) by the scanning unit or the plotting unit based on the comparison results. Hereby, the registration alignment of the scanner or/and the plotter can be automatically executed by the multifunction peripheral, so that it is possible to reduce the dispersion of the registration alignment and shorten the operation time.

A color multifunction peripheral is known, wherein the color correction is executed using a reference pattern data and a color correction coefficient. Hereby, the color correction can be executed optimally and visually in the wide area, such as the initial design of the product, the adjustment of the product at shipping, and the maintenance for correcting the aged deterioration, and the registration of the settings can be operated in a short time.

In the conventional maintenance methods described above, the image forming apparatus is configured that initial values for every setting item have been registered as reference data, but the initial values for every setting item would be changed by a user instruction or the aged deterioration and the changed values are registered as current registered data. Therefore, the image forming apparatus compares the reference data and the current registered data at a predetermined time, and decides the current registered data of the setting item to be adjusted (to restore the current registered data to the reference data), and changes the current registered data of the setting item thus decided to the reference data automatically.

In the conventional maintenance methods, however, it is not possible to decide that the current registered data different from the reference data is the data that the user has changed from the reference data on purpose. Even in case of the current registered data that the user has changed from the reference data on purpose, the current registered data should be restored to the reference data. Therefore, there is a trouble that the user must adjust again the current registered data changed to the reference data.

### SUMMARY OF THE INVENTION

According to one aspect of the disclosure, an image forming apparatus includes a current value comparison unit, a preceding value comparison unit, and a priority order setting unit.

The current value comparison unit is configured to calculate a first variation amount by subtracting a reference value of a reference chart from a current registered value of a current chart for every setting item based on the reference values for every setting item registered in advance and the current registered values for every setting item, when the current chart corresponding to the current registered values for every setting item is outputted.

The preceding value comparison unit is configured to calculate a second variation amount by subtracting the reference value of the reference chart from a preceding registered value of a preceding chart for every setting item based on the reference values and the preceding registered values for every setting item registered before changing the current registered value.

The priority order setting unit is configured to give a higher priority order to the setting item having a larger variation amount based on the first variation amount and the second variation amount and display the setting items in descending order of priorities.

According to another aspect of the disclosure, a maintenance method for image forming apparatus includes steps of a current char comparison step, a preceding value comparison step, and a priority order setting step.

The current value comparison step is configured to calculate a first variation amount by subtracting a reference value of a reference chart from a current registered value of a current chart for every setting item based on the reference values for every setting item registered in advance and the current registered values for every setting item, when the current chart corresponding to the current registered values for every setting item is outputted.

The preceding value comparison step is configured to calculate a second variation amount by subtracting the reference value of the reference chart from a preceding registered value of a preceding chart for every setting item based on the reference values and the preceding registered values for every setting item registered before changing the current chart.

The priority order setting step is configured to give a higher priority order to the setting item having a larger variation amount based on the first variation amount and the second variation amount and display the setting items in descending order of priorities.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and/or other aspects and advantages of the invention will become apparent and more readily appreciated from the following description of the embodiments, taken in conjunction with the accompanying drawings of which:

FIG. 1 is a conceptual diagram indicating a whole structure of an inside of a multifunction peripheral in accordance with an embodiment of the present disclosure.

FIG. 2 is a conceptual diagram indicating a whole structure of an operation unit in accordance with an embodiment of the present disclosure.

FIG. 3 is a diagram indicating a structure of control system hardware of the multifunction peripheral in accordance with an embodiment of the present disclosure.

FIG. 4 is a functional block diagram of the multifunction peripheral in accordance with an embodiment of the present disclosure.

FIG. 5 is a flowchart indicating execution steps in accordance with an embodiment of the present disclosure.

FIG. 6A shows examples of a reference chart and a current chart in accordance with an embodiment of the present disclosure.

FIG. 6B shows examples of the reference chart and a last chart in accordance with an embodiment of the present disclosure.

FIG. 7A is a table indicating calculated a third variation amount in accordance with an embodiment of the present disclosure.

FIG. 7B is a diagram indicating a screen displaying setting items displayed on touch panel in accordance with an embodiment of the present disclosure.

### DETAILED DESCRIPTION OF THE EMBODIMENTS

According to attached drawings, embodiments of the image forming apparatus in the present disclosure are explained hereinafter in order to understand the present disclosure. Besides, the following embodiments are only examples that realize the present disclosure, and do not limit the technical scope of the present disclosure. Additionally, the alphabet “S” in front of a numeral in the flowchart means a “step”.

The image forming apparatus in accordance with the embodiments of the present disclosure is an image forming apparatus including an image reading unit, for example, which is explained hereinafter. The units that do not have direct connection to the present disclosure are explained briefly and the details are omitted.

The image forming apparatus in the present disclosure corresponds to a printer, a scanner, or a multifunction peripheral including a printer, a copier, a scanner, and a facsimile machine, which functions as an image forming apparatus having a copy function, a scanner function, a facsimile function and a printer function.

The working of the multifunction peripheral (MFP) 100 is explained hereinafter briefly.

When a user uses the multifunction peripheral 100, first, the user puts an original on an original plate 101a on a top of housing or a plate 101b of an auto document feeding unit. The user inputs a setting condition of the image forming from an operation screen of an operation unit (an operation panel) 102 near the original plate 101a. The user presses a start key on the operation unit 102, and the multifunction peripheral 100 starts the image forming processing (the printing processing).

In an image reading unit 103, the light emitted from a light source 104 is reflected on the original placed on the original plate 101a. The reflected light is guided to an imaging element 108 by mirrors 105, 106 and 107. The guided light is photo-electrically converted by the imaging element 108, and image data corresponding to the original is formed.

A unit for forming a toner image based on the image data is an image forming unit 109. The image forming unit 109 is provided with a photosensitive drum 110. The photosensitive drum 110 rotates in a predetermined direction at a fixed speed. Around the photosensitive drum 110, a charging unit 111, an exposing unit 112, a developing unit 113, a transfer unit 114, and a cleaning unit 115 are arranged in order from an upstream side of the rotation direction of the photosensitive drum 110.

The charging unit 111 electrifies a surface of the photosensitive drum 110 uniformly. The exposing unit 112 irradiates the laser beam on the surface of the electrified photosensitive drum 110 according to the image data, and forms an electrostatic latent image. The developing unit 113 sticks the toner on the formed electrostatic latent image, and forms a toner image. The formed toner image is transferred to a recoding medium (e.g. a sheet or a paper) by the transfer unit 114. The cleaning unit 115 removes excessive toners remained on the surface of the photosensitive drum 110. This series of process is executed by the rotation of the photosensitive drum.

The paper is supplied from plural paper feed cassettes 116 provided to the multifunction peripheral 100. The supplied paper is pulled out from one of the paper feed cassettes 116 to a conveyance path by a pickup roller 117. The paper feed cassettes 116 store different types of papers respectively, and the paper is supplied based on the setting condition of the image forming.

The paper pulled to the conveyance path is conveyed between the photosensitive drum 110 and the transfer unit 114 by conveyance rollers 118 and resist rollers 119. On the fed paper, the toner image based on the image data is transferred by the transfer unit 114. And then the paper is conveyed to a fixing unit 120.

While the paper on which the toner image was transferred is passing through between a heat roller and a pressure roller provided to the transfer unit 120, the toner image is fixed on the paper by applying the heat and pressure on the toner image. The quantity of heat of the heat roller is predetermined optimally depending on the kind of paper, and the fixing is executed appropriately. The image forming process is terminated after the visible image is fixed on the paper. The paper is guided to a path switching unit 121 by the conveyance roller 118.

The path switching unit 121 guides the paper to a copy receiving tray 122 provided to a side of the housing or a tray 124 built in the housing through a paper discharge port 123, according to a switching instruction of the multifunction peripheral 100. The paper is loaded on and stored in the copy receiving tray 122 or the built-in tray 124. The multifunction peripheral 100 provides the user with the copy function according to the above steps.

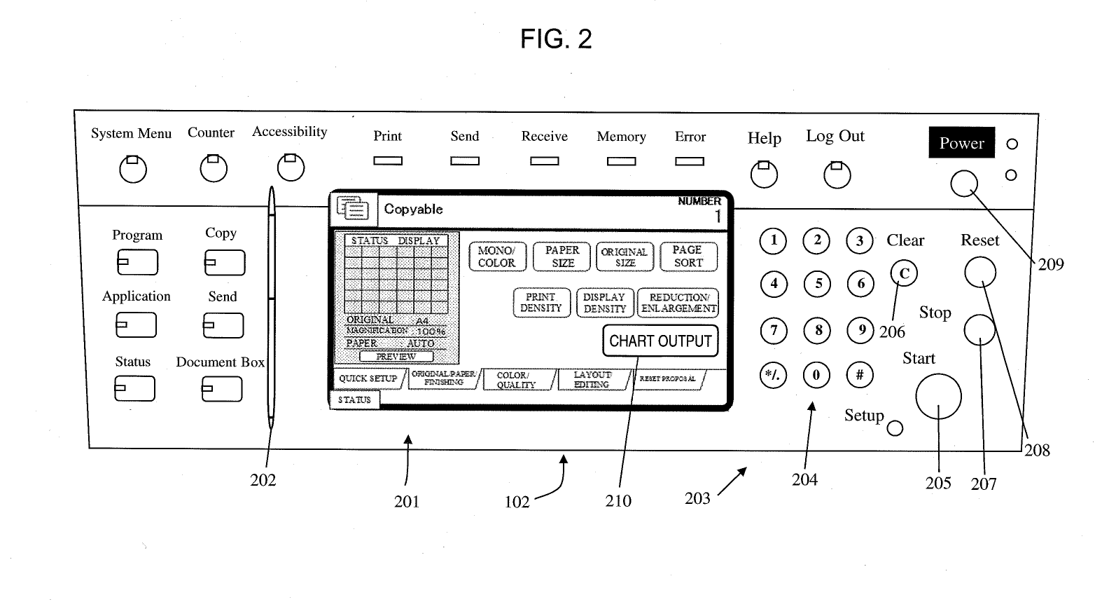

As shown in FIG. 2, the user inputs the setting condition of the image forming as above, and confirms the inputted setting condition by means of the operation unit 102. When the setting condition is inputted, the user uses a touch panel 201 (an operation panel), a touch pen 202, and an operation key 203 that are provided to the operation unit 102.

The touch panel 201 includes both an input function for the setting condition and a displaying function for the setting condition. That is, when the user presses a key on a screen displayed on the touch panel 201, the setting condition corresponding to the pressed key is inputted.

A display unit (not shown) such as a LCD (Liquid Crystal Display) is provided on a back of the touch panel 201. The display unit displays the operation screen, such as an initial screen, for example. The touch pen 202 is provided nearby the touch panel 201, and when the user contacts the touch panel 201 with a tip of the touch pen 202, a sensor under the touch panel 201 detects the contact of the tip.

Nearby the touch panel 201, a specific number of operation keys 203 are arranged, such as a ten key 204, a start key 205, a clear key 206, a stop key 207, a reset key 208, and a power key 209, for example.

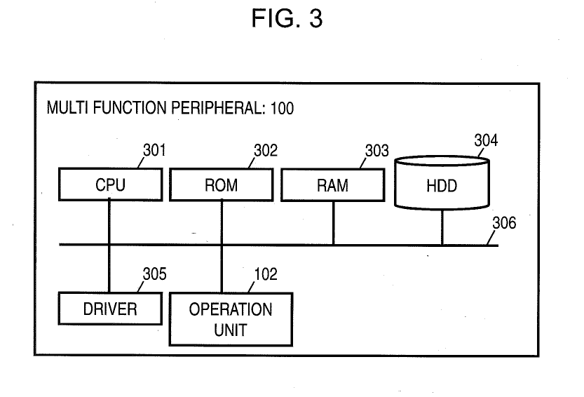

With reference to FIG. 3, the structure of the control system hardware of the multifunction peripheral 100 is explained here. The units that do not have direct relation to the present disclosure are explained briefly, and the details are omitted.

The control circuit of the multifunction peripheral 100 is configured to connect a CPU (Central Processing Unit) 301, a ROM (Read Only Memory) 302, a RAM (Random Access Memory) 303, a HDD (Hard Disk Drive) 304, a driver 305 corresponding to each driving unit, and the operation unit 102 through an internal bus 306.

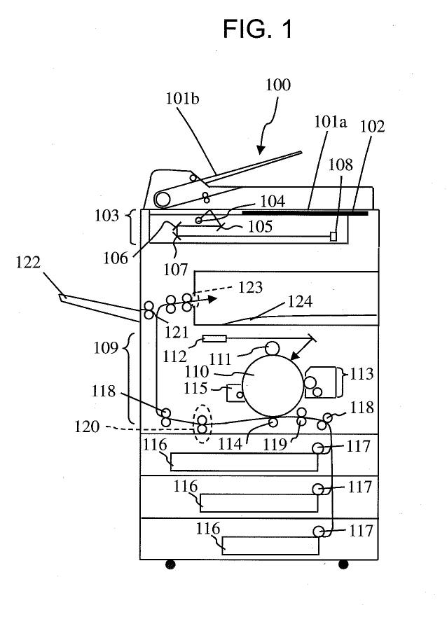

The CPU 301 uses the RAM 303 as a working area, for example, executes programs stored in the ROM 302 and the HDD 304, and sends and receives data and instructions from the driver 305 and the operation unit 102 according to the execution result, signals and commands corresponding to the pressed keys, and controls the operations of each driving unit shown in FIG. 1.

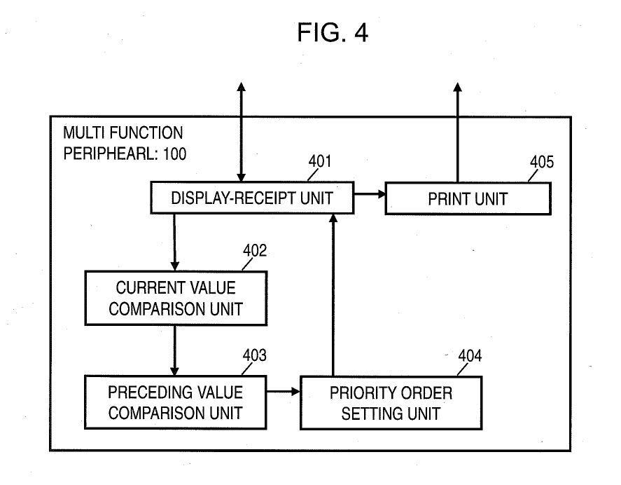

Regarding the under-mentioned units other than the driving unit (shown in FIG. 4), each unit can be materialized by executing the programs by the CPU 301. The ROM 302 and the HDD 304 store the programs or data for materializing the respective units described below.

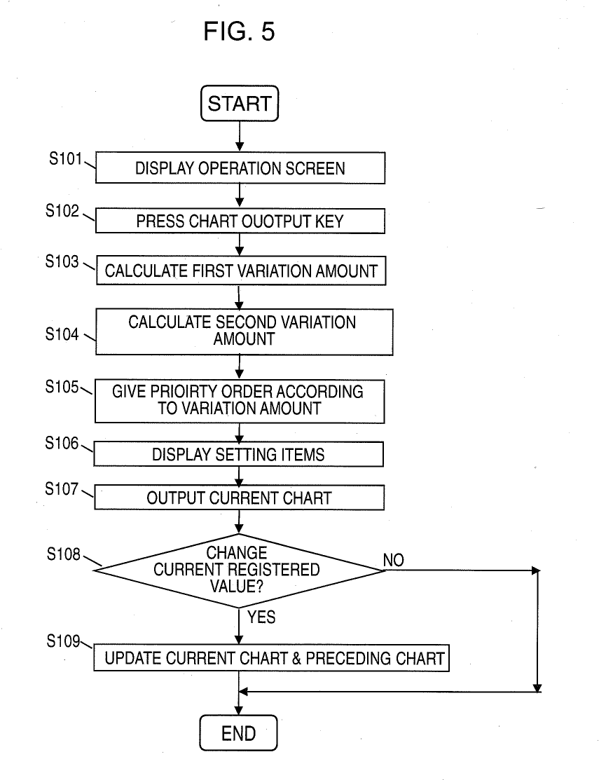

With reference to FIG. 4 and FIG. 5, a structure and execution steps in accordance with embodiments of the present disclosure are explained hereinafter.

When the user powers on the multifunction peripheral 100, the multifunction peripheral 100 is activated and a display-receipt unit 401 displays the operation screen on the touch panel 201 (FIG. 5: S101).

On the operation screen shown in FIG. 2, function item keys and a chart output key 210 are displayed so as to allow the user to press down. The function item keys are configured to input the setting condition of the copy function, for example, and the chart output key 210 is configured to print (output) current registered values (values to be adjusted) for every setting item as a chart described hereinafter, together with displaying a setting item screen for the setting items.

The setting items are items to be finely adjusted for the multifunction peripheral 100 that the users use. These items are a top margin grid, a left margin grid, a voltage, a color density, and a monochrome density, for example. The top margin is a size between a top end of the paper and a position to start printing the image, and the grid is the number of dot sections used to dot matrix font. Therefore, the top margin grid is the number of dot sections representing the top margin. The voltage is the voltage related to the bias of the charging unit 111.

When the user presses the chart output key 210, the receipt-display unit 401 receives an instruction of the chart output (FIG. 5: S102) and sends a notice to a current value comparison unit 402. Upon receipt of the notice, the current value comparison unit 402 refers to reference values of the setting items corresponding to a reference chart registered in advance and current registered values of the setting items corresponding to a current chart, and calculates a first variation amount by subtracting a reference value of the reference chart from a current registered value of the current chart for every setting item (FIG. 5: S103).

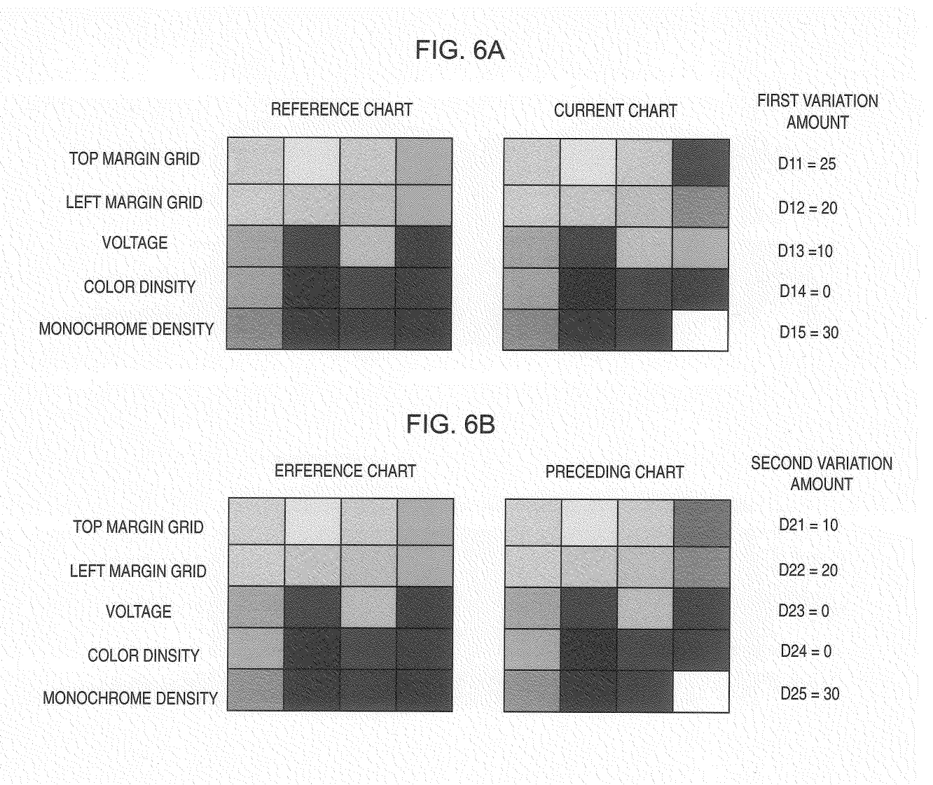

Specifically, the current value comparison unit 402 refers to the reference values corresponding to the reference chart stored in a memory. The reference chart is a chart that reflects the reference values of the setting items registered at the factory shipment, which has been stored being associated with the reference values in the memory of every multifunction peripheral 100 (see FIGS. 6A and 6B). The reference values of the reference chart cannot be changed by any user.

Next, the current value comparison unit 402 refers to the current registered values of the setting items corresponding to the current chart stored in the memory, subtracts the reference value of the reference chart from the current registered value of the current chart for every setting item, and finds the first variation amount for every setting item. The current chart is different from the reference chart, and it represents the current registered values for every setting item. The current registered values of the setting items can be changed by the user through the setting item screen, and the changed values are stored being associated with the current chart.

As shown in FIG. 6A, in case of the top margin grid, when the reference value is subtracted from the current registered value, “25” is found as the first variation amount D11. In case of the left margin grid, “20” is found as the first variation amount D12. In case of the voltage, “10” is found as the first variation amount D13. In case of the color density, “0” is found as the first variation amount D14. In case of the monochrome density, “30” is found as the first variation amount D15. Hereby, it is possible to know, from the first variation amounts, the reduction (change) of the density caused by the aged deterioration and the changes of the margins caused by the aged adjustment when the current chart was registered.

Besides, the chart is a tone image (a tone pattern) wherein the reference values and the current registered values are represented by a color density gradation, as shown in FIG. 6A. When the user sees the chart, he visually knows the changes of the current registered values from the color gradation of the tone image by comparing with the reference values.

When the calculation of the first variation amounts ends, the current value comparison unit 402 notifies a preceding value comparison unit 403 of the end. Upon receipt of the notice, the preceding value comparison unit 403 refers to the reference values of the reference chart and preceding registered values of the setting items corresponding to a preceding chart, the preceding registered values that are the current registered values of the current chart before the current registered values are changed, and calculates second variation amounts by subtracting the reference value of the reference chart from a preceding registered value of the preceding chart for every setting item (FIG. 5: S104).

The preceding chart represents old current registered values of the setting items stored with the preceding chart in the memory before the change of the current registered values, when the current registered values of the current chart were changed. For instance, when the user presses the chart output key 210 and instructs to output the chart and changes (resets) the current registered values of the setting items through the setting item screen, the current registered values for every setting item corresponding the current chart (the registered values after the change) and the preceding registered values for every setting item corresponding to the preceding chart registered before the change of the current registered values (the current registered value before the change) are stored in the memory. In other words, it is configured that, when the current registered values of the current chart are changed, the values registered after the change are stored as the current registered values corresponding to the current chart and the values registered before the change are not deleted but stored in the memory as the preceding registered values of the preceding chart. Since the preceding chart is stored in the memory, it is possible to distinguish the setting items of which registered values have been changed by the user on purpose.

The preceding value comparison unit 403 refers to the preceding registered values of the preceding chart in the memory, and calculates second variation amounts for every setting item by subtracting the reference values of the reference chart from the preceding registered values of the preceding chart for every setting item.

As shown in FIG. 6B, in case of the top margin grid, when the reference value is subtracted from the preceding registered value, “10” is found as the second variation amount D21. In case of the left margin grid, “20” is found as the second variation amount D22. In case of the voltage, “0” is found as the second variation amount D23. In case of the color density, “0” is found as the second variation amount D24. In case of the monochrome density, “30” is found as the second variation amount D25. Hereby, it is possible to know, from the second variation amounts, the reduction of the density caused by the aged deterioration and the changes of the margins caused by the aged adjustment when the preceding chart was registered.

When the calculation of the second variation amounts ends, the preceding value comparison unit 403 notifies a priority order setting unit 404 of the end. Upon receipt of the notice, the priority order setting unit 404 gives the setting item having a larger variation amount a higher priority order based on the first variation amounts and the second variation amounts (FIG. 5: S105), and displays the setting items in descending order of priorities (FIG. 5: S106).

The priority order setting unit 404 compares the first variation amount and the second variation amount for every setting item, and calculates third variation amounts by subtracting the second variation amount from the first variation amount for every setting item. The third variation amount represents that the current registered value is changed from the reference value registered at the factory shipping, and the preceding registered value is also changed from the reference value. In particular, the variation amount of the value that the user has changed on purpose changes significantly while the variation amount of the value caused by the aged deterioration is gradually changed. Accordingly, with respect to the setting item having the large third variation amount, there is a possibility that the user has changed the setting item on purpose.

Therefore, the priority order setting unit 404 gives a higher priority to the setting item having the large third variation amount.

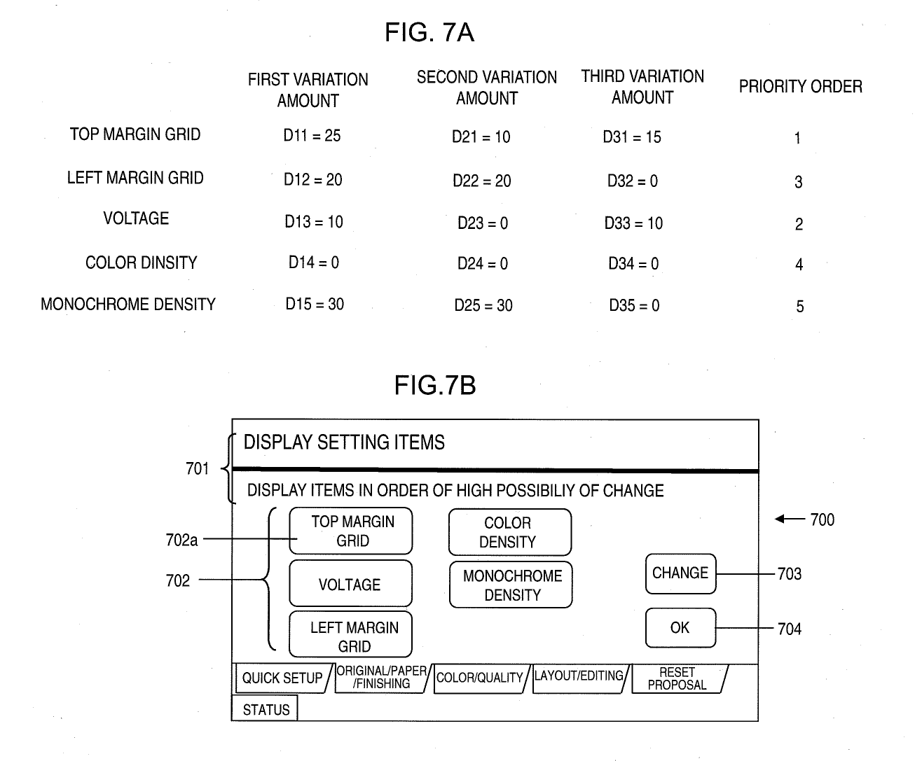

As shown in FIG. 7A, in case of the top margin grid, “15” is found as the third variation amount D31 by subtracting the second variation amount D21 from the first variation amount D11. Likewise, in case of the left margin grid, “0” is found as the third variation amount D32 by subtracting the second variation amount D22 from the first variation amount D12. In case of the voltage, “10” is found as the third variation amount D33 by subtracting the second variation amount D23 from the first variation amount D13. In case of the color density, “0” is found as the third variation amount D34 by subtracting the second variation amount D24 from the first variation amount D14. In case of the monochrome density, “0” is found as the third variation amount D35 by subtracting the second variation amount D25 from the first variation amount D15.

According to the above result, a first priority “1” is given to “the top margin grid” that has the largest third variation amount, and a second priority “2” is given to “the voltage” that has larger third variation amount. The third variation amounts with respect to the other setting items are “0”. Specifically, with respect to the third variation amount, one setting item and the other setting item are the same third variation amount. In this case, the priority order setting unit 404 gives priority to each setting item in descending order of priority according to a predetermined priority order for every setting item. Specifically, the priority order setting unit 404 gives a third priority “3” to “the left margin grid”, a fourth priority “4” to “the color density”, and a fifth priority “5” to “the monochrome density”.

When the priority order setting unit gives the priority orders for every setting item, a setting item screen 700 for displaying the setting items in the descending order of priority is displayed on the display-receipt unit 401.

The setting item screen 700 displays, as shown in FIG. 7B, a specific message 701, such as “Display the setting items” and “Display the items in order of high possibility of change”, the setting item keys 702 that are arranged from an upper left position in descending order of priorities, a change key 703 for changing the current registered value of the setting item, and an OK key 704. Those keys are displayed so as to be pressed by the user. Besides the priority order corresponding to the setting item key may be displayed nearby the setting item key 702.

The setting item keys 702 of which values might be changed by the user are arranged on positions that the user is easy to press down, so that the user can distinguish the setting item changed on purpose from the setting item changed by the aged deterioration. Accordingly, the user can easily recognize the changes of the setting items for multifunction peripheral 100. In addition, since the setting items to change the values can be shown to the user as a candidate, it is possible to smoothly request the user to perform the maintenance operation (to adjust the current registered value of the setting item).

The setting items changed in the past by the user on purpose are displayed as the candidates in order that the user can know at first sight, and the automatic adjustment is not performed so as to automatically change from the current chart to the reference chart. Therefore, the user can adjust the desired setting items appropriately, and the reset operation can be prevented absolutely.

The priority order setting unit 404 displays the setting item screen 700, and then sends a notice to a printing unit 405. Upon receipt of the notice, the printing unit 405 prints out the reference chart and the current chart on a paper as shown in FIG. 6A (FIG. 5: S107).

Therefore, the user can know differences between the reference values of the reference chart at the factory shipment and the current registered values of the current chart by seeing the printed paper at first sight and. The user can recognize the setting items to adjust the current registered values exactly.

Where the above-mentioned adjustment of the current registered values of the setting items is performed on the multifunction peripheral 100 wherein the quality of the printing is deteriorated caused by the long time use, the deteriorated quality can be restored to the quality at the factory shipment, and it is very useful. Where the adjustment of the current registered values of the setting items is entrusted to the user, however, the user cannot decide the current registered values of the setting items to be adjusted because he does not have the technical knowledge, and he must request the service man to perform the maintenance. It is a very troublesome matter.

It is configured in the present disclosure, in order to resolve the above trouble, to output the charts indicating the current registered values of the setting items. Hereby, the user can visually recognize the variation amounts of the current registered values and decide the setting items to be adjusted and the current registered values to be adjusted. As compared with the conventional method for changing all the current registered values to the state of the factory shipment, the user can select the desired setting items according to the priority order and adjust the current registered values of the selected setting items in the method in the present disclosure, so that the user can adjust the current registered values of the setting items appropriately considering the current registered values of the setting items changed by the other user in the past. Therefore, when the user does not wish to restore the current registered values changed on purpose to the initial values at the factory shipment, the present method is very useful.

What the printing unit 405 outputs on the paper is not limited in particular, for instance, it may be a set of the reference chart, the current chart and the preceding chart, or a set of the reference chart, the current chart, the preceding chart, the first variation amounts, the second variation amounts and the third variation amount.

The user presses “the top margin grid” key 702a of the setting item keys and the change key 703 on the setting item screen 700, and changes the current registered value of the “top margin grid” (FIG. 5: S108 YES).

The method of changing the current registered values of the setting items by the user is not limited in particular. For instance, when the “top margin grid” key 702a and the change key 703 are pressed down, an input screen for inputting the value of the “top margin grid” is displayed. The user operates the keys of the input screen, so that the priority order setting unit 404 changes the current registered value of the “top margin grid” to a value specified by the user (a specific value).

After the current registered value of the specified setting item has changed, the user returns to the setting item screen 700 and presses the OK key 704. The display-receipt unit receives the change of the current registered value of the “top margin grid”, and stores the registered value of the setting item after the change in the memory as a new current registered value and current chart (update the current chart). In addition, the display-receipt unit 401 stores the registered value of the setting item before the change (the old current registered value) as the preceding registered value and preceding chart in the memory (update the preceding chart) (FIG. 5: S109). The old preceding value and chart are deleted from the memory. Accordingly, it is configured that the new current value and chart and the new preceding value and chart are stored in the memory when the user changes the current registered value of the setting items, so that the setting of the priority order of the setting items can be changed when the user presses the chart output key 210 again.

On the other hand, when the user presses the OK key 704 on the setting item screen 700 without changing the current registered value of the setting item (FIG. 5: S108 NO), the display-receipt unit 401 displays again the operation screen on the touch panel 201 without changing the current registered values. Hereby, the current registered value and chart and the preceding registered value and chart are kept in the memory, so that the setting of the priority order of the setting items can be reproduced when the user the chart output key 210.

As described above, in the present disclosure, the user can confirm the setting item changed on purpose with ease.

In the embodiment of the present disclosure, it is configured that the chart output key 210 is displayed on the operation panel, but the display position is not limited to this. For instance, the char output key 210 may be displayed on a system screen that is displayed by a specific user (an administrator) instead of the operation screen.

In the above embodiment of the present disclosure, it is configured to store respective charts being associated with respective values (the reference value, the current registered value, and the preceding value) in the memory, however, it may be configured to create and output the charts corresponding to the respective values when the user presses the chart output key.

In the embodiment, it is configured that the preceding chart were stored in the memory in advance. In this case, it means that the user has changed the current registered value of the setting item twice at least at different times. For instance, when the user changed the current registered value of the setting item only once, the preceding registered value and chart do not exist. Therefore, the preceding value comparison unit 403 may regard the current registered value and chart as the preceding value and chart, and calculate the second variation amount. In this case, the first variation amount becomes the same as the second variation amount, and the third variation amounts become “0” with respect to all the setting items. The priority order of the setting items become the predetermined order. Besides, the predetermined priority order is the order of the setting items listed in the memory, for example.

Moreover, the embodiment of the present disclosure, the multifunction peripheral 100 is configured to include each unit, but it may be configured that a program for materializing the units is stored in a storage medium and the storage medium is provided. In such configuration, the program is read on the multifunction peripheral 100, and the multifunction peripheral 100 materializes the respective units. In this case, the program read from the storage medium provides the effect of the present disclosure. Additionally, the steps executed by the respective units may be stored in the hard disk.

What is claimed is:

1. An image forming apparatus comprising:
a current value comparison unit configured to calculate a first variation amount by subtracting a reference value of a reference chart from a current registered value of a current chart for every setting item based on the reference values for every setting item registered in advance and the current registered values for every setting item, when the current chart corresponding to the current registered values for every setting item is outputted;
a preceding value comparison unit configured to calculate a second variation amount by subtracting the reference value of the reference chart from a preceding registered value of a preceding chart for every setting item based on the reference values and the preceding registered values for every setting item registered before changing the current registered value; and
a priority order setting unit configured to give a higher priority order to the setting item having a larger variation amount based on the first variation amount and the second variation amount and display the setting items in descending order of priorities.

2. The image forming apparatus according to claim 1, wherein
the priority order setting unit calculates third variation amounts by subtracting the second variation amount from the first variation amount for every setting item and gives a higher priority order to the setting item having a larger third variation amount.

3. The image forming apparatus according to claim 2, wherein
when plural setting items have a same third variation amount, the priority order setting unit gives priority to each setting item in descending order of priorities according to a predetermined priority order for every setting item.

4. The image forming apparatus according to claim 1, wherein
the priority order setting unit displays setting item keys corresponding to the setting items together with a change key for changing the current registered value of the setting item and changes the current registered value of the setting item when the user selects a specific setting item key and the change key.

5. The image forming apparatus according to claim 1, wherein
the priority order setting unit displays setting item keys corresponding to the setting items, priority orders of the setting items, and a change key for changing the current registered value of the setting item and changes the current registered value of the setting item when the user selects a specific setting item key and the change key.

6. The image forming apparatus according to claim 1, further comprising:
a printing unit configured to print the reference chart and the current chart on a paper when the chart corresponding to the current registered values for every setting item is outputted.

7. The image forming apparatus according to claim 1, further comprising:
a receipt-display unit receives a change of a specific setting item of the setting items, stores a value of the setting item registered in a memory after the change as a new current registered value and the current registered value of the setting item registered before the change in the memory as a preceding registered value.

8. The image forming apparatus according to claim 1, wherein
the setting items include one of a top margin grid, a left margin grid, a voltage, a color density, and a monochrome density.

9. The image forming apparatus according to claim 1, wherein
the current value comparison unit calculates the first variation amount when the output of the chart is instructed from a system screen that a specific user can display.

10. The image forming apparatus according to claim 1, wherein
when the user changed the current registered value of the setting item only once, the preceding value comparison unit 403 regards the current registered value as the preceding registered value, and calculate the second variation amount, and
the priority order setting unit sets the priority order of the setting item to a predetermined order.

11. A maintenance method for image forming apparatus comprising steps of:
a current value comparison step configured to calculate a first variation amount by subtracting a reference value of a reference chart from a current registered value of a current chart for every setting item based on the reference values for every setting item registered in advance and the current registered values for every setting item, when the current chart corresponding to the current registered values for every setting item is outputted;
a preceding value comparison step configured to calculate a second variation amount by subtracting the reference value of the reference chart from a preceding registered value of a preceding chart for every setting item based on the reference values and the preceding registered values for every setting item registered before changing the current registered value; and
a priority order setting step configured to give a higher priority order to the setting item having a larger variation amount based on the first variation amount and the second variation amount and displays the setting items in descending order of priorities.
